(19) United States
(12) Patent Application Publication
(10) Pub. No.: US 2019/0051147 A1
(43) Pub. Date: Feb. 14, 2019

(54) REMOTE CONTROL METHOD, APPARATUS, TERMINAL DEVICE, AND COMPUTER READABLE STORAGE MEDIUM

(71) Applicant: YULONG COMPUTER TELECOMMUNICATION SCIENTIFIC (SHENZHEN) CO., LTD., Shenzhen (CN)

(72) Inventors: Jianbo Xiong, Shenzhen (CN); Yongyuan Duan, Shenzhen (CN)

(73) Assignee: YULONG COMPUTER TELECOMMUNICATION SCIENTIFIC SHENZHEN) CO., LTD., Shenzhen (CN)

(21) Appl. No.: 16/054,626

(22) Filed: Aug. 3, 2018

(30) Foreign Application Priority Data
Aug. 14, 2017 (CN) 201710693071.8

(51) Int. Cl. G08C 17/02; H04M 1/725; H04M 1/253

(52) U.S. Cl. CPC G08C 17/02; G08C 2201/93; H04M 1/2535; H04M 1/7253

(57) ABSTRACT

The present invention discloses a remote control method, apparatus, terminal device, and computer readable storage medium, wherein, the method comprises: receiving a screen image of a controlled terminal device from the controlled terminal device; generating an operation instruction according to the screen image; sending the operation instruction to the controlled terminal device to control the controlled terminal device. The present invention solves the problems such as complicated operation and poor real-time effect when a control terminal device remotely controls a controlled terminal device in prior art, and the present invention realizes real-time control over a controlled terminal device by a control terminal device.

### CROSS REFERENCE TO RELATED APPLICATIONS

This application claims priority of Chinese Patent Application No. 201710693071.8 filed on Aug. 14, 2017, entitled “Remote Control Method, Apparatus, Terminal Device, And Computer Readable Storage Medium”, which is incorporated herein by reference in its entirety.

### TECHNICAL FIELD

The present disclosure relates to the field of telecommunication technology, and in particular relates to a remote control method, apparatus, terminal device, and computer readable storage medium.

### BACKGROUND

With the rapid development of telecommunication technology, the mobile communication network has evolved from 2G network to 3G network and then to the current 4G network, and the corresponding data transmission rate is becoming faster and faster. Starting from the 3G network, video call can be supported.

In the current 4G network, Long-Term Evolution (LTE) network has already been widely used and is currently the mobile communication network with the fastest network speed. A mobile terminal device can use the LTE network to conduct a VOLTE video call. VOLTE refers to Voice Over LTE, which is an IP data transmission technology able to realize unification of data service and voice service under the same network. During a VOLTE video call, both sides of the conversation send images to each other by using the photographing function and IP Multimedia Subsystem protocol stack manipulation on the mobile terminal device, so that one side's image can be clearly seen by the other side.

In practical application, when a user conducts a video call, there often is a situation that one mobile terminal device needs to remotely control the other mobile terminal device. Chinese patent literature CN102170617A discloses that, during the process of a call between a recognizes the voice data and acquires an operation instruction corresponding to the voice data; the second mobile terminal device executes a corresponding operation according to the operation instruction. Thus, during remote assistance between mobile terminal devices in prior art, in a call process, the controlled terminal device recognizes a voice keyword sent from the control terminal device, converts the voice keyword into a corresponding operation code, and executes a corresponding operation according to the operation code, thereby completing remote control of the controlled terminal device by the control terminal device. In this kind of remote control method, the controlled terminal device has to learn the keywords related to the operation codes beforehand, in order to be correctly operated, which has relatively poor user experience; and in a process of carrying out the control, the control terminal device never knows whether the controlled terminal device has executed the corresponding operation, or to what extent the operation has been executed, which has poor real-time effect; also, the operation codes set beforehand are fixed, which does not have enough practicability.

### SUMMARY

In consideration of this, the embodiments of the present disclosure provide a remote control method, apparatus, terminal device, and computer readable storage medium, in order to solve the problem of operation being complicated and real-time effect being poor when a control terminal device remotely controls a controlled terminal device in prior art.

Thus, the embodiments of the present disclosure provide the following technical solutions:

According to the first aspect of the present disclosure, a remote control method, applied to a control terminal device, comprises receiving a screen image of a controlled terminal device from the controlled terminal device; generating an operation instruction according to the screen image; sending the operation instruction to the controlled terminal device to control the controlled terminal device.

In combination with the first aspect of the present disclosure, in a first embodiment of the first aspect of the present disclosure, the step of generating an operation instruction according to the screen image comprises: displaying the screen image, and performing a designated operation on the displayed screen image; recording coordinates information of the designated operation relative to a screen of the controlled terminal device; generating an operation instruction according to the designated operation and the coordinates information.

In combination with the first aspect of the present disclosure or the first embodiment of the first aspect of the present disclosure, in a second embodiment of the first aspect of the present disclosure, before receiving the screen image of the controlled terminal device from the controlled terminal device, the method comprises: establishing a VOLTE video call connection with the controlled terminal device.

According to the second aspect of the present disclosure, a remote control method, applied to a controlled terminal device, comprises sending a screen image of the controlled terminal device to a control terminal device; receiving an operation instruction from the control terminal device, the operation instruction is generated by the control terminal device according to the screen image; executing a corresponding operation according to the operation instruction.

In combination with the second aspect of the present disclosure, in a first embodiment of the second aspect of the present disclosure, the step of executing a corresponding operation according to the operation instruction comprises: analyzing the operation instruction to obtain a designated operation performed on the screen image and coordinates information of the designated operation relative to a screen of the controlled terminal device; executing a corresponding operation according to the designated operation and the coordinates information.

In combination with the second aspect of the present disclosure or the first embodiment of the second aspect of the present disclosure, in a second embodiment of the second aspect of the present disclosure, before sending the screen image of the controlled terminal device to the control terminal device, the method comprises: establishing a VOLTE video call connection with the control terminal device.

According to the third aspect of the present disclosure a remote control apparatus, applied to a control terminal device, comprises a receiving module, for receiving a screen image of a controlled terminal device from the controlled terminal device; a generating module, for generating an operation instruction according to the screen image; a sending module, for sending the operation instruction to the controlled terminal device to control the controlled terminal device.

In combination with the third aspect of the present disclosure, in a first embodiment of the third aspect of the present disclosure, the generating module comprises: a display unit, for displaying the screen image and performing a designated operation on the displayed screen image; a recording unit, for recording coordinates information of the designated operation relative to a screen of the controlled terminal device; a generating unit, for generating an operation instruction according to the designated operation and the coordinates information.

in combination with the third aspect of the present disclosure or the first embodiment of the third aspect of the present disclosure, in a second embodiment of the third aspect of the present disclosure, the apparatus comprises: a connection module, for establishing a VOLTE video call connection with the controlled terminal device before receiving the screen image of the controlled terminal device from the controlled terminal device.

According to the fourth aspect of the present disclosure, a remote control apparatus, applied to a controlled terminal device, comprises a sending module, for sending a screen image of the controlled terminal device to a control terminal device; a receiving module, for receiving from the control terminal device an operation instruction which is generated by the control terminal device according to the screen image; an execution module, for executing a corresponding operation according to the operation instruction.

In combination with the fourth aspect of the present disclosure, in a first embodiment of the fourth aspect of the present disclosure, the execution module comprises: an analyzing unit, for analyzing the operation instruction and obtain a designated operation performed on the screen image and coordinates information of the designated operation relative to a screen of the controlled terminal device; an execution unit, for executing a corresponding operation according to the designated operation and the coordinates information.

In combination with the fourth aspect of the present disclosure or the first embodiment of the fourth aspect of the present disclosure, in a second embodiment of the fourth aspect of the present disclosure, the apparatus comprises: a connection module, for establishing a VOLTE video call connection with the control terminal device before sending the screen image of the controlled terminal device to the control terminal device.

According to the fifth aspect of the present disclosure, a terminal device provided comprises at least one processor, and a memory communicably connected with the at least one processor; the memory stores instructions that are executable by the at least one processor, the instructions are executed by the at least one processor to cause the at least one processor to perform the steps of any of the methods according to the above-mentioned first aspect.

According to the sixth aspect of the present disclosure, a computer readable storage medium, with computer instructions stored thereon, is provided, when the instructions are executed by a processor, the steps of any of the methods according to the above-mentioned first aspect are performed.

According to the seventh aspect of the present disclosure, a terminal device provided comprises at least one processor, and a memory communicably connected with the at least one processor; the memory stores instructions that are executable by the at least one processor, the instructions are executed by the at least one processor to cause the at least one processor to perform the steps of any of the methods according to the above-mentioned second aspect.

According to the eighth aspect of the present disclosure, a computer readable storage medium, with computer instructions stored thereon, is provided, when the instructions are executed by a processor, the steps of any of the methods according to the above-mentioned second aspect are performed.

The technical solutions of the embodiments of the present disclosure have the following advantages:

The embodiments of the present disclosure provide a remote control method, apparatus, terminal device, and computer readable storage medium, the method comprises: receiving a screen image of a controlled terminal device from the controlled terminal device, specifically, establishing a VOLTE video call connection between the control terminal device and the controlled terminal device, using the transmission technology in the VOLTE video call to carry out data transmission between the control terminal device and the controlled terminal device, so that the control terminal device can acquire the status of the controlled terminal device in real time; the control terminal device generates an operation instruction according to the screen image, and sends the operation instruction to the controlled terminal device to control the controlled terminal device. The present disclosure solves the problems such as complicated operation and poor real-time effect when a control terminal device of prior arts is used to remotely control a controlled terminal device, and the present disclosure realizes real-time control over a controlled terminal device by a control terminal device.

### BRIEF DESCRIPTION OF THE DRAWINGS

In order to more clearly describe the technical solutions in the embodiments of the present disclosure or in prior art, hereinafter, the accompanying drawings to be used for describing the specific embodiments or prior art will be briefly introduced. Apparently, the accompanying drawings described below are only directed to some embodiments of the present disclosure, and for a person skilled in the art, without expenditure of creative labor, other drawings can be derived on the basis of these accompanying drawings.

FIG. 1 shows a structural diagram of a cellphone in the embodiments of the present disclosure;

FIG. 2 is a flow chart of a remote control method according to the embodiments of the present disclosure;

FIG. 3 is another flow chart of a remote control method according to the embodiments of the present disclosure;

FIG. 4 is an interaction diagram between a control terminal device and a controlled terminal device according to the embodiments of the present disclosure;

FIG. 5 is another interaction diagram between a control terminal device and a controlled terminal device according to the embodiments of the present disclosure;

FIG. 6 is a structural block diagram of a remote control apparatus according to ⁻the embodiments of the present disclosure;

FIG. 7 is another structural block diagram of a remote control apparatus according to the embodiments of the present disclosure;

FIG. 8 is a hardware structural schematic diagram of a control terminal device provided by the embodiments of the present disclosure;

FIG. 9 is a hardware structural schematic diagram of a controlled terminal device provided by the embodiments of the present disclosure.

### DETAILED DESCRIPTION

In order for the objectives, features and advantages of the present disclosure to be more clearly understood, hereinafter, a clear and complete description of the technical solution in embodiments of the present disclosure is provided in combination with the accompanying drawings of the embodiments of the present disclosure. Apparently, the embodiments described below are part of, but not all of, the embodiments of the present disclosure. All the other embodiments, obtained by a person skilled in the art on the basis of the embodiments described in the present disclosure without expenditure of creative labor, belong to the protection scope of the present disclosure.

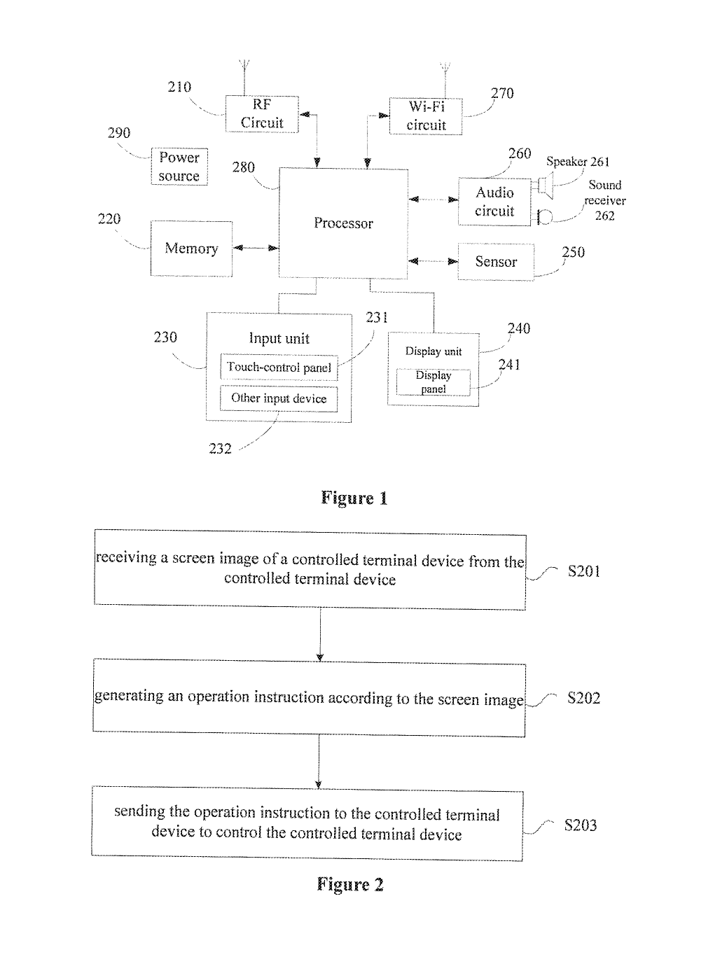

As shown in FIG. 1, it is an application scene schematic diagram of the embodiments of the present disclosure. The control terminal device and the controlled terminal device may be a mobile device such as a cellphone or a tablet computer. A cellphone is taken as an example of the control terminal device and the controlled terminal device, and a partial structural block diagram of the cellphone is shown in FIG. 1, the cellphone comprises a radio-frequency circuit 210, a memory 220, an input unit 230, a display unit 240, a sensor 250, an audio circuit 260, a wireless module 270, a processor 280, a power source 290, etc. And a person skilled in the art can understand that, the cellphone structure shown in FIG. 1 does not constitute a limitation to the cellphone, the cellphone may comprise more components or less components than what is shown in this Figure, or some components may be combined, or there is a different layout of the components.

Optionally, the RF circuit 210 is used for receiving and sending signals in a process of information transmission or voice call. The memory 220 is used for storing software programs and modules, the processor 280 executes various application functions and data processing of the cellphone by running the software programs and modules stored in the memory 220. The input unit 230 may comprise a touch-control panel 231 or other input devices 232. Said other input devices 232 may include, but not limited to, one or more selected from a physical keyboard, a function button, a mouse, a joystick. The display unit 240 is used for displaying information inputted by a user, or information to be provided to a user, or various menus of the cellphone. The display unit 240 may comprise a display panel 241. The touch-control panel 231 may cover the display panel 241, and when the touch-control panel 231 detects a touch operation on it or in the proximity of it, the touch-control panel 231 transmits signal to the processor 280 so as to determine a type of the touch incident, and then the processor 280 provides a corresponding visual output on the display panel 241 according to the type of the touch incident.

The cellphone may also comprise at least one kind of sensor 250, such as an optical sensor, a motion sensor or other sensors. The optical sensor may comprise an environment light sensor and a proximity sensor, optionally the environment light sensor can adjust the luminance of the display panel 241 according to the brightness of environment light, and the proximity sensor can turn off the display panel 241 and/or the backlight when the cellphone is moved into proximity of the user's ear. The optical sensor in this embodiment may be provided on a casing at a front side or a back side of the cellphone, for detecting a shading area when the use holds the cellphone. Also, the cellphone may also comprise a pressure sensor provided on a casing at a front side or a back side of the cellphone, for determining the shading area when the use holds the cellphone, by detecting a pressure. In addition, the cellphone may also be equipped with other sensors such as a gyroscope, a barometer, a hygrometer, a thermometer, an infrared ray sensor, which are not cumbersomely described herein.

The audio circuit 260, together with a speaker 261 and a sound receiver 262, can provide an audio interface between the user and the cellphone. The wireless module 270 may be a Wi-Fi module, which provides wireless interact access service to the user.

The processor 280 is a control center of the cellphone, which interconnects the respective components of the entire cellphone by using various interfaces and wires and executes various functions and data processing of the cellphone by running or executing the software programs and/or modules stored in the memory 220 as well as calling the data stored in the memory 220, so as to monitor the cellphone as a whole. Optionally, the processor 280 may comprise one or more processing units. Also, the cellphone comprises the power source 290 for supplying power to the respective components, and the power source 290 is logically connected to the processor 280 through a power management system, so as to realize functions such as charge and discharge management, energy consumption management, etc. by means of the power management system.

Although not shown, the cellphone may also comprise a camera, a Bluetooth module, etc., which are not cumbersomely described herein.

One embodiment provides a remote control method, applied to the above-mentioned control terminal device, such as a cellphone or a tablet computer. FIG. 2 is a flow chart of a remote control method according to the embodiments of the present disclosure. As shown in FIG. 2, the method flow comprises the following steps:

Step S201: receiving a screen image of a controlled terminal device from the controlled terminal device. In particular, a VOLTE video call connection is established between the control terminal device and the controlled terminal device, and the control terminal device and the controlled terminal device use the transmission technology in the VOLTE video call to carry out data transmission. In an optional embodiment, the control terminal device receives, from the controlled terminal device, screen information recorded in real time by the controlled terminal device. In another optional embodiment, when the control terminal device and the controlled terminal device perform a VOLTE video call, the control terminal device receives in real time, from the controlled terminal device, screen images captured by the controlled terminal device. As a result, the control terminal device can acquire in real time the running status of the controlled terminal device.

Step S202: generating an operation instruction according to the screen image. In particular, the control terminal device displays the screen image received from the controlled terminal device, and by means of the displayed screen image, the control terminal device can perform operations such as clicking, sliding, long pressing on its screen, collect the coordinates information of the aforementioned various operations relative to the screen of the controlled terminal device, and generate the above-mentioned operation instruction.

Step S203: sending the operation instruction to the controlled terminal device to control the controlled terminal device. In particular, the controlled terminal device may analyze the above-mentioned operation instruction and convert the operation instruction into a screen interaction operation corresponding to itself, so as to realize real-time control of the controlled terminal device by the control terminal device.

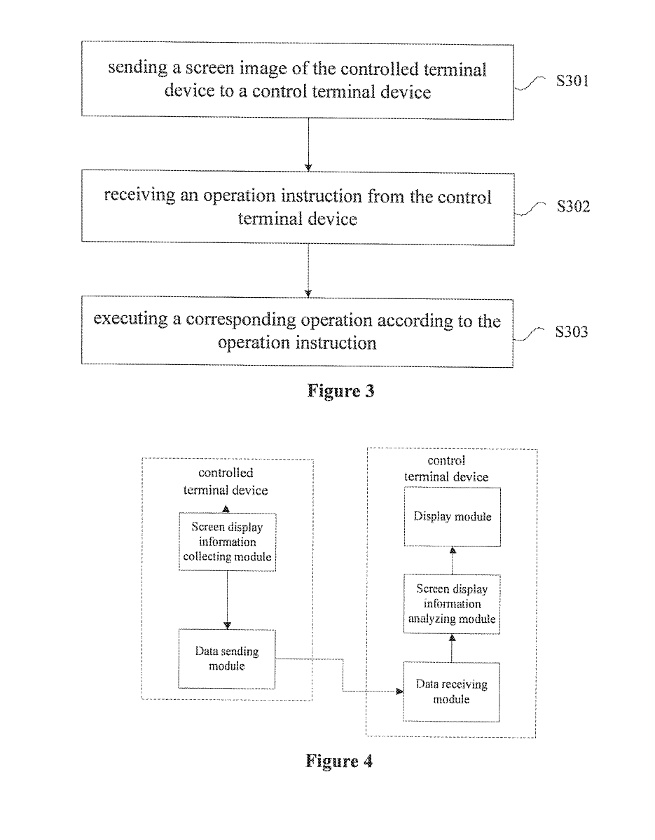

One embodiment provides another remote control method, applied to the above-mentioned controlled terminal device, such as a cellphone or a tablet computer. FIG. 3 is another flow chart of a remote control method according to the embodiments of the present disclosure. As shown in FIG. 3, the method flow comprises the following steps:

Step S301: sending a screen image of the controlled terminal device to a control terminal device. In particular, a VOLTE video call connection is established between the control terminal device and the controlled terminal device, and the control terminal device and the controlled terminal device use the transmission technology in the VOLTE video call to carry out data transmission. In an optional embodiment, the controlled terminal device records in real time its own screen, and continuously sends the recorded video information to the control terminal device. In another optional embodiment, when the control terminal device and the controlled terminal device perform a VOLTE video call, an image-capturing module of the controlled terminal device captures a screen image of its own and sends the captured screen image to the control terminal device for once every predetermined interval. As a result, the control terminal device can acquire in real time the running status of the controlled terminal device.

Step S302: receiving an operation instruction from the control terminal device, the operation instruction is generated by the control terminal device according to the screen image. In particular, the control terminal device displays the screen image received from the controlled terminal device, and by means of the displayed screen image, the control terminal device can perform operations such as clicking, sliding, long pressing on its screen, collect the coordinates information of the aforementioned various operations relative to the screen of the controlled terminal device, and generate the above-mentioned operation instruction.

Step S303: executing a corresponding operation according to the operation instruction. In particular, the controlled terminal device analyzes the above-mentioned operation instruction to obtain a designated operation performed on the screen image and coordinates information of the designated operation relative to the screen of the controlled terminal device, and converts these information into a screen interaction operation corresponding to itself, so as to realize real-time control of the controlled terminal device by the control terminal device.

Hereinafter, in combination with an information interaction process between the control terminal device and the controlled terminal device, examples for carrying out remote control of the controlled terminal device by the control terminal device are described.

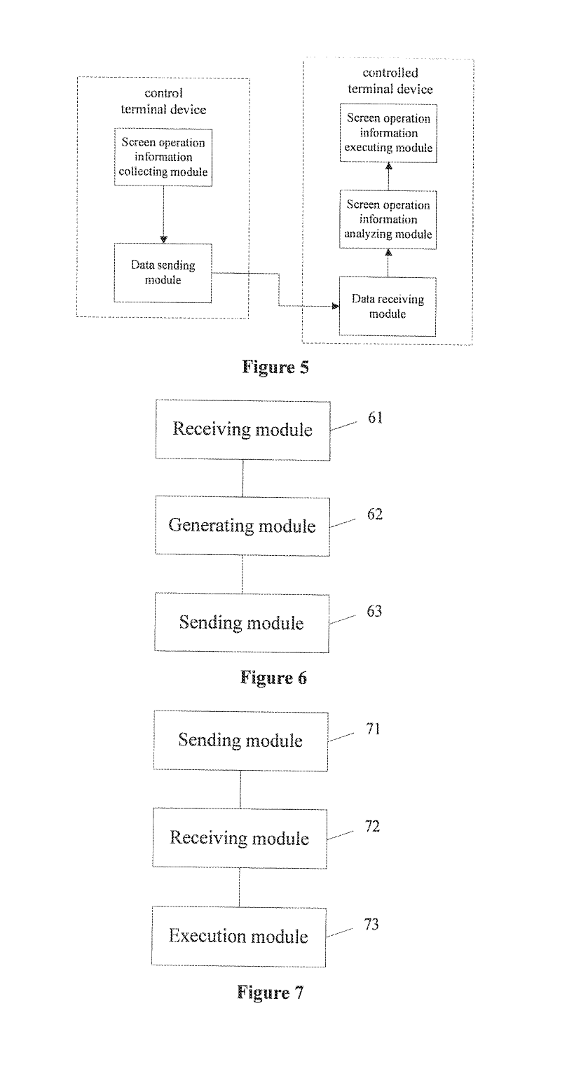

As shown in FIGS. 4 and 5, a screen display information collecting module is for collecting screen information of the controlled terminal device; a data sending module is for adding the data customized by the present solution into the VOLTE video transmission protocol according to the way how a VOLTE video call transmits video data; a data receiving module is for decompose the data customized by the present solution from the standard protocol according to the way how a VOLTE video call transmits video data; a screen display information analyzing module is for analyzing the received data to obtain the screen video data that needs to be displayed; a display module is for displaying the screen video data; a screen operation information collecting module is for recording the type of the screen operation (such as clicking, sliding, long pressing), the dimension size of the screen, and relative position of the operated coordinates point (relative position of x, y coordinates in the screen), so as to facilitate precise redoing of the designated operation at the controlled terminal device; a screen operation information analyzing module is for decompose the type of the screen operation (such as clicking, sliding, long pressing), the dimension size of the screen, and relative position of the operated coordinates point (relative position of x, y coordinates in the screen) from the received data; and a screen operation information executing module is for redoing the designated operation at a corresponding position by using the obtained operation information data.

By means of the above-mentioned embodiment, in order for a control terminal device to truly realize real-time control over a controlled terminal device and for the control terminal device to be able to see in real-time the images of the controlled terminal device, the relatively stable communication technology of the existing VOLTE is utilized to transmit the screen information from the controlled terminal device to the control terminal device and transmit the operation information from the control terminal device back to the controlled terminal device, the controlled terminal device executes the received operation instruction, then the controlled terminal device again sends its screen information back to the control terminal device, so on and so forth executed in cycles, thereby completing real-time control of the controlled terminal device by the control terminal device. Because the transmission technology in the VOLTE video call is utilized, there is no need to provide an additional server to perform data relay, therefore low cost, safety and reliability are realized, and in the meantime the practicability of VOLTE video call is diversified, therefore the user experience is improved.

One embodiment provides a remote control apparatus, this apparatus is for carrying out the above-mentioned embodiments and their preferred implementing ways, and those already described will not be repeatedly described herein. As used below, the term “module” may be a combination of software and/or hardware for carrying out predetermined functions. Although the apparatus described in the embodiments below are preferably realized by software, implementation by hardware or by a combination of software and hardware can also be possibly conceived.

FIG. 6 is a structural block diagram of a remote control apparatus according to the embodiments of the present disclosure, which is applied to a control terminal device. As shown in FIG. 6, the apparatus comprises: a receiving module 61, for receiving a screen image of a controlled terminal device from the controlled terminal device; a generating module 62, for generating an operation instruction according to the screen image; a sending module 63, for sending the operation instruction to the controlled terminal device to control the controlled terminal device.

Optionally, the generating module 62 comprises: a display unit, for displaying the screen image and performing a designated operation on the displayed screen image; a recording unit, for recording coordinates information of the designated operation relative to a screen of the controlled terminal device; a generating unit, for generating an operation instruction according to the designated operation and the coordinates information.

Optionally,the apparatus also comprises: a connection module, for establishing a VOLTE video call connection with the controlled terminal device before receiving the screen image of the controlled terminal device from the controlled terminal device.

The remote control apparatus in this embodiment is illustrated in a form of functional units, herein, the unit refers to an ASIC circuit, a processor and a memory for executing one or more software or fixed program, and/or other devices able to provide the above-mentioned functions.

Further functional description of the above-mentioned modules is the same as that of the corresponding embodiments above, which is not repeatedly described herein.

Another embodiment provides a remote control apparatus for carrying out the above-mentioned embodiments and their preferred implementing ways, and those already described will not be repeatedly described herein. As used below, the term “module” may be a combination of software and/or hardware for carrying out predetermined functions. Although the apparatus described in the embodiments below are preferably realized by software, implementation by hardware or by a combination of software and hardware can also be possibly conceived.

FIG. 7 is another structural block diagram of a remote control apparatus according to the embodiments of the present disclosure, which is applied to a controlled terminal device. As shown in FIG. 7, the apparatus comprises: a sending module 71, for sending a screen image of the controlled terminal device to a control terminal device; a receiving module 72, for receiving from the control terminal device an operation instruction which is generated by the control terminal device according to the screen image; an execution module 73, for executing a corresponding operation according to the operation instruction.

Optionally, the execution module 73 comprises: an analyzing unit, for analyzing the operation instruction and obtain a designated operation performed on the screen image and coordinates information of the designated operation relative to a screen of the controlled terminal device; an execution unit, for executing a corresponding operation according to the designated operation and the coordinates information.

Optionally, the apparatus also comprises: a connection module, for establishing a VOLTE video call connection with the control terminal device before sending the screen image of the controlled terminal device to the control terminal device.

The remote control apparatus in this embodiment is illustrated in a form of functional units, herein, the unit refers to an ASIC circuit, a processor and a memory for executing one or more software or fixed program, and/or other devices able to provide the above-mentioned functions.

Further functional description of the above-mentioned modules is the same as that of the corresponding embodiments above, which is not repeatedly described herein.

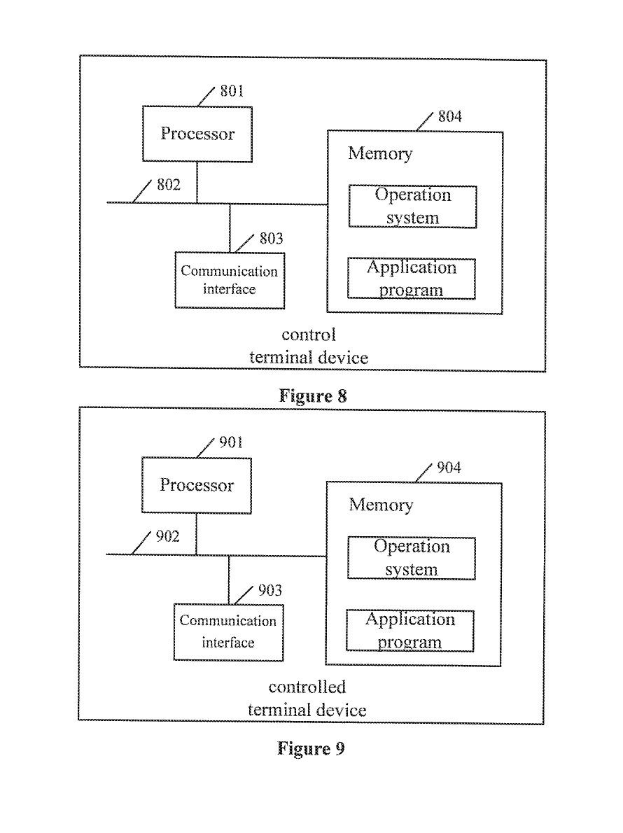

Referring to FIG. 8 which is a structural schematic diagram of a control terminal device provided by the optional embodiments of the present disclosure. As shown in FIG. 8, the terminal device comprises: at least one processor 801, for example a Central Processing Unit (CPU), at least one communication interface 803, a memory 804, and at least one communication bus 802. Optionally, the communication bus 802 is for realizing connection communication between these components. Optionally, the communication interface 803 may comprise a Display, a Keyboard, and optionally the communication interface 803 may also comprise a standard wired interface or wireless interface. The memory 804 may be a high-speed volatile Random Access Memory, or may be a non-volatile memory, for example a magnetic disk memory. The memory 804 may optionally be at least one storage device remote from the aforementioned processor 801. Optionally, the processor 801 can refer to the described apparatus in FIG. 6, the memory 804 stores a set of program codes, and the processor 801 calls the program codes stored in the memory 804 to execute a remote control method, i.e. to perform the following steps:

receiving a screen image of a controlled terminal device from the controlled terminal device;

generating an operation instruction according to the screen image;

sending the operation instruction to the controlled terminal device to control the controlled terminal device.

In the embodiments of the present disclosure, the processor 801 calls the program codes stored in the memory 804 to also perform the following steps:

displaying the screen image, and performing a designated operation on the displayed screen image;

recording coordinates information of the designated operation relative to a screen of the controlled terminal device;

generating an operation instruction according to the designated operation and the coordinates information.

In the embodiments of the present disclosure, the processor 801 calls the program codes stored in the memory 804 to also perform the following step:

establishing a VOLTE video call connection with the controlled terminal device.

Optionally, the communication bus 802 may be a Peripheral Component Interconnecting (PCI) bus or an Extended industry Standard Architecture bus. The communication bus 802 may be classified into an address bus, a data bus, a control bus, etc. For easy illustration, only one thick line is used in FIG. 8 to show it, but this does not mean there is only one bus or there is only one type of bus.

Optionally, the memory 804 may comprise a volatile memory such as a Random Access Memory (RAM); the memory 804 may also comprise a non-volatile memory such as a flash memory, a hard disk drive (HDD) or a Solid State Drive (SSD); the memory 804 may also comprise a combination of the aforementioned types of memory devices.

Optionally, the processor 801 may be a Central Processing Unit (CPU), a Network Processor (NP), or a combination of CPU and NP.

Optionally, the processor 801 may further comprise a hardware chip. The aforementioned chip may be an Application Specific Integrated Circuit (ASIC), a Programmable Logic Device (PLD), or a combination thereof. The aforementioned PLD may be a Complex Programmable Logic Device (CPLD), a Field-Programmable Gate Array (FPGA), a Generic Array Logic (GAL), or a combination thereof.

Optionally, the memory 804 may store program instructions. The processor 801 may call the program instructions to carry out the remote control methods shown in the embodiments of FIGS. 2, 4, 5 of the present application.

Referring to FIG. 9 which is a structural schematic diagram of a controlled terminal device provided by the optional embodiments of the present disclosure. As shown in FIG. 9, the terminal device comprises: at least one processor 901, for example a Central Processing Unit (CPU), at least one communication interface 903, a memory 904, and at least one communication bus 902. Optionally, the communication bus 902 is for realizing connection communication between these components. Optionally, the communication interface 903 may comprise a Display, a Keyboard, and optionally the communication interface 903 may also comprise a standard wired interface or wireless interface. The memory 904 may be a high-speed volatile Random Access Memory, or may be a non-volatile memory, for example a magnetic disk memory. The memory 904 may optionally be at least one storage device remote from the aforementioned processor 801. Optionally, the processor 901 can refer to the described apparatus in FIG. 6, the memory 904 stores a set of program codes, and the processor 901 calls the program codes stored in the memory 904 to execute a remote control method, i.e. to perform the following steps:

sending a screen image of the controlled terminal device to a control terminal device;

receiving an operation instruction from the control terminal device, the operation instruction is generated by the control terminal device according to the screen image;

executing a corresponding operation according to the operation instruction.

In the embodiments of the present disclosure, the processor 901 calls the program codes stored in the memory 904 to also perform the following steps:

analyzing the operation instruction to obtain a designated operation performed on the screen image and coordinates information of the designated operation relative to a screen of the controlled terminal device;

executing a corresponding operation according to the designated operation and the coordinates information.

In the embodiments of the present disclosure, the processor 901 calls the program codes stored in the memory 904 to also perform the following steps:

establishing a VOLTE video call connection with the control terminal device.

Optionally, the communication bus 902 may be a Peripheral Component Interconnecting (PCI) bus or an Extended Industry Standard Architecture bus. The communication bus 802 may be classified into an address bus, a data bus, a control bus, etc. For easy illustration, only one thick line is used in FIG. 9 to show it, but this does not mean there is only one bus or there is only one type of bus.

Optionally, the memory 904 may comprise a volatile memory such as a Random Access Memory (RAM); the memory 904 may also comprise a non-volatile memory such as a flash memory, a hard disk drive (HDD) or a Solid State Drive (SSD); the memory 904 may also comprise a combination of the aforementioned types of memory devices.

Optionally, the processor 901 may be a Central Processing Unit (CPU), a Network Processor (NP), or a combination of CPU and NP.

Optionally, the processor 901 may further comprise a hardware chip. The aforementioned chip may be an Application Specific Integrated Circuit (ASIC), a Programmable Logic Device (PLD), or a combination thereof. The aforementioned PLD may be a Complex Programmable Logic Device (CPLD), a Field-Programmable Gate Array (FPGA), a Generic Array Logic (GAL), or a combination thereof.

Optionally, the memory 904 may store program instructions. The processor 901 may call the program instructions to carry out the remote control methods shown in the embodiments of FIGS. 2, 4, 5 of the present application.

The embodiments of the present disclosure also provide a non-transient computer storage medium, the computer readable storage medium stores computer executable instructions, the computer executable instructions can execute the remote control method in any of the above-mentioned method embodiments. Optionally, the storage medium may be a magnetic disk, an optical Disk, a Read-Only Memory (ROM), a Random Access Memory (RAM), a Flash Memory, a Hard Disk Drive (HDD) or a Solid-State Drive (SSD); the storage medium may also comprise a combination of the aforementioned types of memory devices.

Although some embodiments of the present disclosure are described in combination with the accompanying drawings, a person skilled in the art can make various changes and modifications without departing from the essence and scope of the present disclosure, and these changes and modifications should all be embraced in the scope defined by the appended Claims.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A remote control method, applied to a control terminal device, comprising:
receiving a screen image of a controlled terminal device from the controlled terminal device;
generating an operation instruction according to the screen image;
sending the operation instruction to the controlled terminal device to control the controlled terminal device.

2. The method of claim 1, wherein, the step of generating an operation instruction according to the screen image comprises:
displaying the screen image, and performing a designated operation on the displayed screen image;
recording coordinates information of the designated operation relative to a screen of the controlled terminal device;
generating an operation instruction according to the designated operation and the coordinates information.

3. The method of claim 1, wherein, before receiving the screen image of the controlled terminal device from the controlled terminal device, the method comprises:
establishing a VOLTE video call connection with the controlled terminal device.

4. A remote control method, applied to a controlled terminal device, comprising:
sending a screen image of the controlled terminal device to a control terminal device;
receiving an operation instruction from the control terminal device, wherein the operation instruction is generated by the control terminal device according to the screen image;
executing a corresponding operation according to the operation instruction.

5. The method of claim 4, wherein, the step of executing a corresponding operation according to the operation instruction comprises:
analyzing the operation instruction to obtain a designated operation performed on the screen image and coordinates information of the designated operation relative to a screen of the controlled terminal device;
executing a corresponding operation according to the designated operation and the coordinates information.

6. The method of claim 4, wherein, before sending the screen image of the controlled terminal device to the control terminal device, the method comprises:
establishing a VOLTE video call connection with the control terminal device.

7. A terminal device, comprising: at least one processor, and a memory communicably connected with the at least one processor; wherein, the memory stores instructions that are executable by the at least one processor, the instructions are executed by the at least one processor to cause the at least one processor to perform the remote control method comprising the steps
receiving a screen image of a controlled terminal device from the controlled terminal device;
generating an operation instruction according to the screen image;
sending the operation instruction to the controlled terminal device to control the controlled terminal device.

8. The terminal device of claim 7, wherein, the step of generating an operation instruction according to the screen image comprises:
displaying the screen image, and performing a designated operation on the displayed screen image;
recording coordinates information of the designated operation relative to a screen of the controlled terminal device;
generating an operation instruction according to the designated operation and the coordinates information.

9. The terminal device of claim 7, wherein, before receiving the screen image of the controlled terminal device from the controlled terminal device, the method further comprises establishing a VOLTE video call connection with the controlled terminal device.

10. A computer readable storage medium, with computer instructions stored thereon, wherein the instructions when executed by a processor cause the processor to perform the remote control method according to claim 1.

11. The computer readable storage medium of claim 10, wherein, the step of generating an operation instruction according to the screen image comprises:
displaying the screen image, and performing a designated operation on the displayed screen image;
recording coordinates information of the designated operation relative to a screen of the controlled terminal device;
generating an operation instruction according to the designated operation and the coordinates information.

12. The computer readable storage medium of claim 10, wherein, before receiving the screen image of the controlled terminal device from the controlled terminal device, the method further comprises establishing a VOLTE video call connection with the controlled terminal device.

13. A terminal device, comprising: at least one processor, and a memory communicably connected with the at least one processor; wherein, the memory stores instructions that are executable by the at least one processor, the instructions are executed by the at least one processor to perform the steps of remote control method according to claim 4.

14. The terminal device of claim 13, wherein, the step of executing a corresponding operation according to the operation instruction comprises:
analyzing the operation instruction to obtain a designated operation performed on the screen image and coordinates information of the designated operation relative to a screen of the controlled terminal device;
executing a corresponding operation according to the designated operation and the coordinates information.

15. The terminal device of claim 13, wherein, before sending the screen image of the controlled terminal device to the control terminal device, the method comprises establishing a VOLTE video call connection with the control terminal device.

16. A computer readable storage medium, with computer instructions stored thereon, wherein the instructions when executed by a processor cause the processor to perform the remote control method according to claim 4.

17. The computer readable storage medium of claim 16, wherein, the step of executing a corresponding operation according to the operation instruction comprises:
analyzing the operation instruction to obtain a designated operation performed on the screen image and coordinates information of the designated operation relative to a screen of the controlled terminal device;
executing a corresponding operation according to the designated operation and the coordinates information.

18. The computer readable storage medium of claim 16, wherein, before sending the screen image of the controlled terminal device to the control terminal device, the method comprises establishing a VOLTE video call connection with the control terminal device.
